(19) United States
(12) Patent Application Publication
(10) Pub. No.: US 2026/0367624 A1
(43) Pub. Date: Nov. 19, 2026

(54) REMOTE TRAVEL DEVICE

(71) Applicant: TOYOTA JIDOSHA KABUSHIKI KAISHA, Toyota-shi (JP)

(72) Inventors: Tatsuya SUGANO, Seto-shi (JP); Takahiro YAMAMOTO, Toyota-shi (JP); Chenyang WANG, Nagoya-shi (JP)

(73) Assignee: TOYOTA JIDOSHA KABUSHIKI KAISHA, Toyota-shi (JP)

(21) Appl. No.: 19/663,622

(22) Filed: Apr. 30, 2026

(30) Foreign Application Priority Data
May 14, 2025 (JP) 2025-080988

(51) Int. Cl. G05D 1/226; B60R 25/01; B60R 25/24; B60R 25/40; G05D 1/222; G07C 9/00; G07C 9/22; G05D 107/13; G05D 109/10; G05D 111/30

(52) U.S. Cl. CPC G05D 1/2265; B60R 25/01; B60R 25/24; B60R 25/403; G05D 1/222; G07C 9/00309; G07C 9/22; B60R 2325/101; B60R 2325/205; G05D 2107/13; G05D 2109/10; G05D 2111/30; G07C 2009/00642; G07C 2009/00793; G07C 2209/63

(57) ABSTRACT

A remote travel device receives a travel instruction via first communication, causes a control unit to execute remote travel control of causing a vehicle that is parked to travel to a predetermined target space in response to the travel instruction, communicates, via second communication using a protocol different from a protocol of first communication, with an electronic key terminal that is carried by a portable terminal or a user and that is used to perform unlocking and locking of a door of a vehicle even when a vehicle power supply of the vehicle is in an off state, determines whether an activation condition that is predetermined is satisfied based on a communication result of the second communication when the vehicle power supply is in the off state, and establishes, when the activation condition is satisfied, the first communication and turns on the vehicle power supply to activate a control unit.

### CROSS-REFERENCE TO RELATED APPLICATION

This application claims priority to Japanese Patent Application No. 2025-080988 filed on May 14, 2025. The disclosure of the above-identified application, including the specification, drawings, and claims, is incorporated by reference herein in its entirety.

### BACKGROUND

### 1. Technical Field

The present disclosure relates to a remote travel device that executes remote travel control of causing a vehicle that is parked to travel to a predetermined target space in response to a travel instruction transmitted from a portable terminal when a user outside the vehicle performs a predetermined remote operation on the portable terminal.

### 2. Description of Related Art

In the related art, a remote travel device that executes remote travel control is known. For example, the remote travel device (hereinafter, referred to as a "device in the related art") described in Japanese Unexamined Patent Application Publication No. 2022-048453 (JP 2022-048453 A) establishes "communication (first communication) for transmitting data required for remote travel control" between "a portable terminal carried by a user and remotely operated by the user" when a legitimate user who has an electronic key is positioned within a communicable range of the electronic key when a power supply (vehicle power supply) of the vehicle is in an off state. Specifically, the device in the related art activates a data communication unit (DCU) to establish the first communication. In the related art, establishment of the first communication is premised on a remote travel application running on the portable terminal.

After the first communication is established, when the user performs a predetermined start operation on the portable terminal, the portable terminal transmits a start instruction to the device in the related art. When the start instruction is received, the device in the related art turns on the power supply of the vehicle and activates a "control unit (parking ECU) that executes remote travel control".

### SUMMARY

Establishment of first communication and activation of a control unit require time. Since the device in the related art starts the establishment of the first communication and the activation of the control unit at different timings, a long time may be required until remote travel control can be started. Specifically, the user needs to wait until the first communication is established before performing the start operation, and needs to wait until the control unit is activated after performing the start operation.

The present disclosure has been made to solve the above-described problem. That is, one object of the present disclosure is to provide a remote travel device that can reduce a time until the remote travel control can be started.

A remote travel device (hereinafter, referred to as "the device of the present disclosure") according to the present disclosure is configured to receive, via first communication, a travel instruction transmitted from a portable terminal when a user outside a vehicle performs a predetermined remote operation on the portable terminal, and to cause a control unit (30) to execute remote travel control of causing the vehicle that is parked to travel to a predetermined target space in response to the travel instruction (steps 500 to 595).

The remote travel device is configured to communicate, via second communication using a protocol different from a protocol of the first communication, with an electronic key terminal that is carried by the portable terminal or the user and that is used to perform unlocking and locking of a door of the vehicle, even when a vehicle power supply (26) of the vehicle is in an off state (204), determine, when the vehicle power supply is in the off state ("Yes" in step 305), whether an activation condition that is predetermined is satisfied based on a communication result of the second communication (step 310), and establish (step 315), when the activation condition is satisfied ("Yes" in step 310), the first communication and turn on the vehicle power supply to activate (step 320) the control unit.

When the predetermined activation condition is satisfied based on the communication result of the second communication, the device of the present disclosure establishes the first communication and activates the control unit. As a result, since the first communication is established and the control unit is activated at the same time, the time until the remote travel control can be started can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic system configuration diagram of a remote travel device according to an embodiment of the present disclosure;

FIG. 2 is a sequence diagram of an operation of the remote travel device according to the embodiment of the present disclosure;

FIG. 3 is a flowchart of an activation routine executed by a CPU of a body ECU shown in FIG. 1;

FIG. 4 is a flowchart of a remote travel control preparation routine executed by a CPU of a remote travel ECU shown in FIG. 1; and

FIG. 5 is a flowchart of a remote travel control routine executed by the CPU of the remote travel ECU shown in FIG. 1.

### DETAILED DESCRIPTION OF EMBODIMENTS

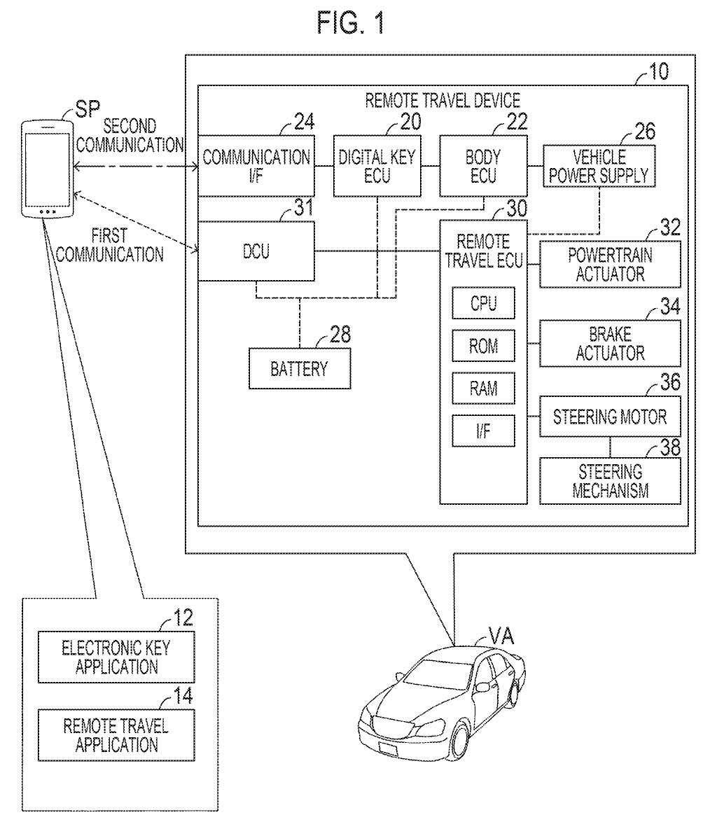

As shown in FIG. 1, a remote travel device 10 (hereinafter, referred to as "the device 10") according to the present embodiment is applied to a vehicle VA. The device 10 transmits and receives data to and from a portable terminal SP operated by the user via the first communication and the second communication. An electronic key application 12 and a remote travel application 14 are installed in the portable terminal SP. The electronic key application 12 performs unlocking and locking of a door of the vehicle VA. The remote travel application 14 causes the device 10 to execute remote travel control described below. The remote travel application 14 transmits and receives data to and from the vehicle VA via the first communication, and the electronic key application 12 transmits and receives data to and from the vehicle VA via the second communication. For example, the first communication is Bluetooth (registered trademark), and the second communication is Bluetooth (registered trademark) Low Energy (hereinafter, referred to as "BLE").

The device 10 includes the components shown in FIG. 1. In the present specification, the "ECU" is an electronic control device including a microcomputer as a main part. The ECU is also referred to as a controller and a computer. The microcomputer includes a CPU (processor), a ROM, a RAM, an interface (I/F), and the like. A function realized by the ECU may be realized by a plurality of ECUs.

A digital key ECU 20 performs the collation of the portable terminal SP (for example, a smartphone) when the portable terminal SP is positioned within a range in which the portable terminal SP can transmit and receive data via the second communication. Specifically, the digital key ECU 20 acquires an electronic key ID set in the electronic key application 12, and determines that the collation is satisfied when the electronic key ID matches a legitimate electronic key ID set in the digital key ECU 20. When the collation is satisfied, the digital key ECU 20 establishes the second communication with the portable terminal SP.

The body ECU 22 changes the vehicle power supply 26, which is a power supply of the vehicle VA, "from the off state to the on state" or "from the on state to the off state". For example, when an ignition key switch (not shown) of the vehicle VA is changed from an off position to an on position, the body ECU 22 changes the vehicle power supply 26 from the off state to the on state.

When the vehicle power supply 26 is in the off state, the vehicle power supply 26 does not supply power to any ECU. However, since the digital key ECU 20, the body ECU 22, and a communication interface (I/F) 24 are supplied with power from a battery 28 mounted in the vehicle VA, these components are activated even when the vehicle power supply 26 is in the off state. Therefore, even when the vehicle power supply 26 is in the off state, the device 10 can communicate data with the portable terminal SP via the second communication. In general, the data communication unit (DCU) 31 is not supplied with power from the battery 28, but when an activation condition described below is satisfied, the DCU 31 is supplied with power from the battery 28.

When the vehicle power supply 26 is turned on, power is supplied to a "remote travel ECU 30 that does not receive power from the battery 28 when the vehicle power supply 26 is in the off state", and a remote travel ECU 30 is activated. When power is supplied to the remote travel ECU 30, power is also supplied to a powertrain actuator 32, a brake actuator 34, and a steering motor 36.

The communication I/F 24 transmits and receives data to and from the portable terminal SP via the second communication.

The remote travel ECU 30 executes remote travel control described below. The DCU 31 transmits and receives data to and from the portable terminal SP via the first communication. The remote travel ECU 30 may be referred to as a "control unit".

The powertrain actuator 32 changes a drive force generated by a drive device (for example, either or both of an internal combustion engine and an electric motor) of the vehicle VA. The brake actuator 34 controls a braking force applied to the vehicle VA. The steering motor 36 is incorporated into a steering mechanism 38. The steering mechanism 38 is a mechanism for turning the steered wheels in response to an operation of a steering wheel. Further, the steering motor 36 causes the steering mechanism 38 to generate an automatic steering torque for changing a steering angle of the steered wheels in response to an instruction from the remote travel ECU 30.

### Remote Travel Control

The user outside the vehicle VA may perform a remote operation on the portable terminal SP. The remote travel control is control of causing the vehicle VA to travel from a parking space by causing the vehicle VA that is parked to travel to a predetermined target space in response to the travel instruction transmitted from the portable terminal SP in this case. In the remote travel control, the device 10 transmits and receives data required for the remote travel control, such as the travel instruction, to and from the remote travel application 14 of the portable terminal SP via the first communication.

### Summary of Operation

When the remote travel control is started, the vehicle VA is parked, so that the vehicle power supply 26 is in the off state and the DCU 31 is not activated. Therefore, the second communication can be established between the device 10 and the portable terminal SP, but the first communication cannot be established. Therefore, when the remote travel control is started, the DCU 31 needs to be activated to establish the first communication. Further, when the remote travel control is started, the vehicle power supply 26 needs to be changed from the off state to the on state to activate the remote travel ECU 30.

[ 0021 ] When the first communication is established and the remote travel ECU 30 is activated at different timings, a long time is required until the remote travel control can be started. Therefore, when the vehicle power supply 26 is in the off state, the device 10 determines whether the predetermined activation condition is satisfied based on the communication result of the second communication. When a determination is made that the activation condition is satisfied, the device 10 activates the DCU 31 to establish the first communication, and changes the vehicle power supply 26 from the off state to the on state to activate the remote travel ECU 30.

As a result, the device 10 can perform the establishment of the first communication and the activation of the remote travel ECU 30 in parallel, so that the time until the remote travel control can be started can be reduced.

### Operations

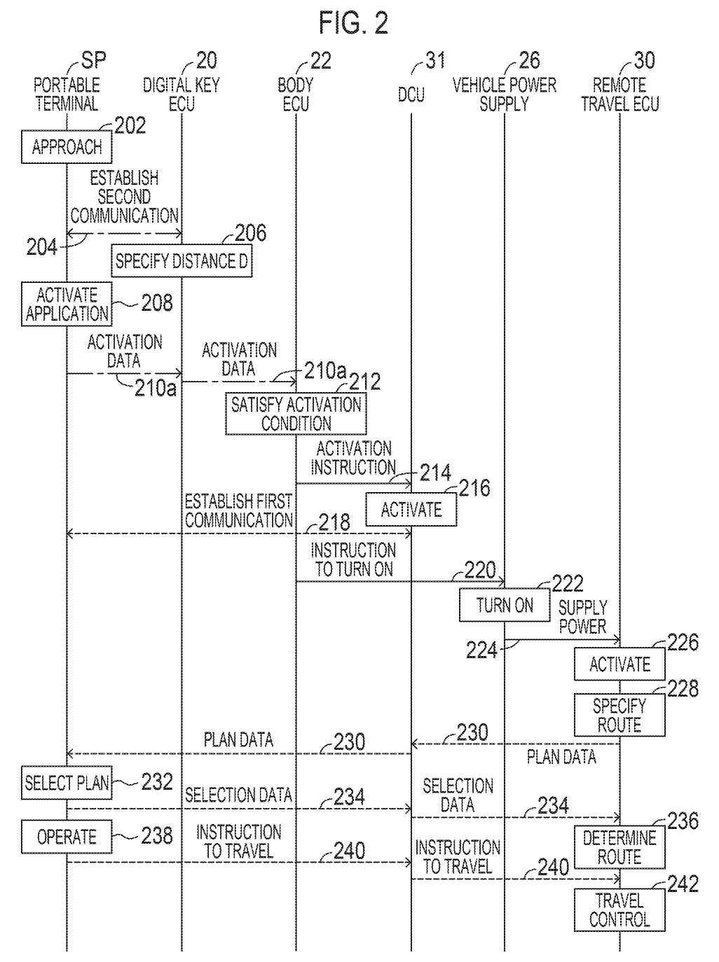

The operation of the device 10 will be described with reference to FIG. 2.

First, the portable terminal SP approaches the vehicle VA (202), and the portable terminal SP is positioned within a range in which the portable terminal SP can transmit and receive data via the second communication. In this case, when the collation is satisfied, the digital key ECU 20 establishes the second communication between the portable terminal SP and the vehicle VA (204). When the second communication is established, the digital key ECU 20 specifies a distance D between the portable terminal SP and the vehicle VA by communicating with the portable terminal SP via the second communication each time a predetermined time elapses (206).

Thereafter, the user operates the portable terminal SP to activate the remote travel application 14 (208). When the remote travel application 14 is activated, the portable terminal SP transmits activation data to the vehicle VA via the first communication (210a). When the communication I/F 24 of the device 10 receives the activation data, the digital key ECU 20 transmits the activation data to the body ECU 22 (210b).

When the activation data is received and the distance D is equal to or less than a threshold distance Dth, the body ECU 22 determines that the activation condition is satisfied (212). When a determination is made that the activation condition is satisfied, the body ECU 22 transmits an activation instruction to the DCU 31 (214) and activates the DCU 31 (216). Specifically, power is supplied to the DCU 31 from the battery 28. When the DCU 31 is activated, the first communication is established between the portable terminal SP and the vehicle VA (218).

When the activation condition is satisfied, the body ECU 22 transmits an on instruction to the vehicle power supply 26 (220) and changes the vehicle power supply 26 from the off state to the on state (222). When the vehicle power supply 26 is turned on, power is supplied to the remote travel ECU 30 (224), and the remote travel ECU 30 is activated (226).

When the remote travel ECU 30 is activated by the activation condition being satisfied, the remote travel ECU 30 specifies at least one route for the vehicle VA to leave the parking space (228). The remote travel ECU 30 transmits plan data including the specified route to the portable terminal SP via the first communication (230).

When the plan data is received, the portable terminal SP (remote travel application 14) displays a selection screen. On the selection screen, the route included in the plan data is displayed. The user selects one route from among the routes displayed on the selection screen (232). When the user selects the route, the portable terminal SP (remote travel application 14) transmits selection data including the selected route to the vehicle VA via the first communication (234).

When the device 10 receives the selection data, the remote travel ECU 30 determines the route included in the received selection data as a traveling route on which the vehicle VA travels (236).

When the route is selected on the selection screen, the portable terminal SP (remote travel application 14) displays an operation screen. The user places a finger on an operation input region of the operation screen and continues to move the finger. This operation is referred to as a "remote operation". While the user is performing the remote operation, the portable terminal SP (remote travel application 14) transmits the travel instruction to the device 10 via the first communication each time a predetermined time elapses (240).

When the device 10 receives the travel instruction, the remote travel ECU 30 controls the powertrain actuator 32, the brake actuator 34, and the steering motor 36 such that the vehicle VA travels along the traveling route (242).

### Specific Operation

### Activation Routine

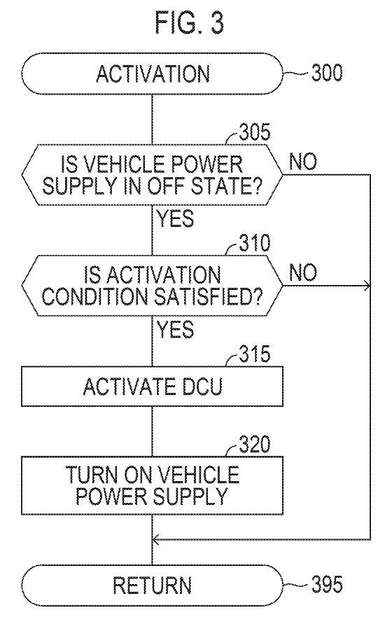

A CPU (hereinafter, referred to as a "first CPU") of the body ECU 22 executes a routine shown in a flowchart in FIG. 3 each time a predetermined time elapses.

When an appropriate point in time arrives, the first CPU starts the process from step 300, and the process proceeds to step 305. In step 305, the first CPU determines whether the vehicle power supply 26 is in the off state.

When the vehicle power supply 26 is in the off state, the first CPU determines "Yes" in step 305, and the process proceeds to step 310. In step 310, the first CPU determines whether the activation condition is satisfied, the activation condition being that activation data has been received and that the distance D is less than or equal to a threshold distance Dth.

When the activation condition is not satisfied, the first CPU determines "No" in step 310, and the process proceeds to step 395. In step 395, the first CPU temporarily ends the present routine.

On the other hand, when the activation condition is satisfied, the first CPU determines "Yes" in step 310, and executes step 315 and step 320.

Step 315: The first CPU activates the DCU 31.

Step 320: The first CPU turns on the vehicle power supply 26 to activate the remote travel ECU 30.

Thereafter, the process proceeds to step 395.

In a case where the vehicle power supply 26 is in the on state when the process proceeds to step 305, the first CPU determines "No" in step 305, and the process proceeds to step 395.

### Remote Travel Control Preparation Routine

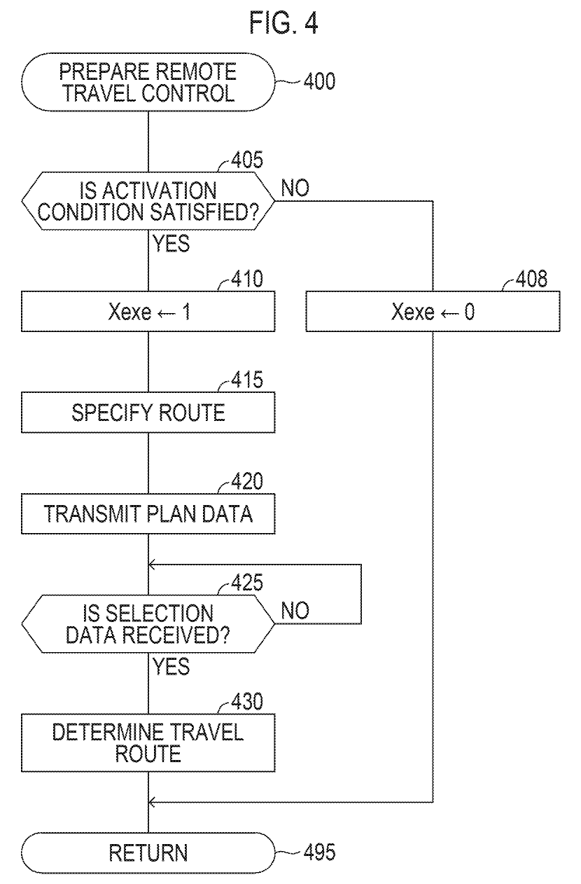

A CPU (hereinafter, referred to as a "second CPU") of the remote travel ECU 30 executes a routine shown in a flowchart in FIG. 4 when the remote travel ECU 30 is activated.

When the remote travel ECU 30 is activated, the second CPU starts the process from step 400, and the process proceeds to step 405. In step 405, the second CPU determines whether the activation condition is already satisfied.

When the activation condition is not satisfied, the remote travel ECU 30 is activated by changing the ignition key switch to the on position. Therefore, the remote travel ECU 30 does not need to execute the remote travel control. Therefore, the second CPU determines "No" in step 405, and the process proceeds to step 408. In step 408, the second CPU sets an execution flag Xexe to "0". The execution flag Xexe is set to "1" when the remote travel control is executed, and is set to "0" when the remote travel control is not executed. Thereafter, the process proceeds to step 495. In step 495, the second CPU temporarily ends the present routine.

On the other hand, when the activation condition is already satisfied, the remote travel ECU 30 needs to execute the remote travel control. In this case, the second CPU determines "Yes" in step 405, and executes step 410 to step 425.

Step 410: The second CPU sets the execution flag Xexeto "1".

Step 415: The second CPU specifies a route for the vehicle VA to leave the parking space.

Specifically, the second CPU specifies at least one stopping space where the vehicle VA can be parked based on an image of the periphery of the vehicle VA captured by a camera (not shown) mounted in the vehicle VA. Then, the second CPU specifies at least one route from the stopping space to each parking space based on the image.

Step 420: The second CPU transmits plan data including the route specified in step 415 to the portable terminal SP via the first communication.

Step 425: The second CPU determines whether the device 10 has received the selection data from the portable terminal SP via the first communication.

When the device 10 receives the selection data, the second CPU determines "Yes" in step 425, and the process proceeds to step 430. In step 430, the second CPU determines the route selected by the user as the traveling route. The second CPU determines the stopping space of the route selected by the user as the target space. Thereafter, the process proceeds to step 495.

On the other hand, when the device 10 does not receive the selection data, the second CPU determines "No" in step 425, and executes step 425 again. When the state where the device 10 does not receive the selection data continues for a predetermined time or longer, the second CPU may cancel the remote travel control by setting the execution flag Xexe to "0".

### Remote Travel Control Routine

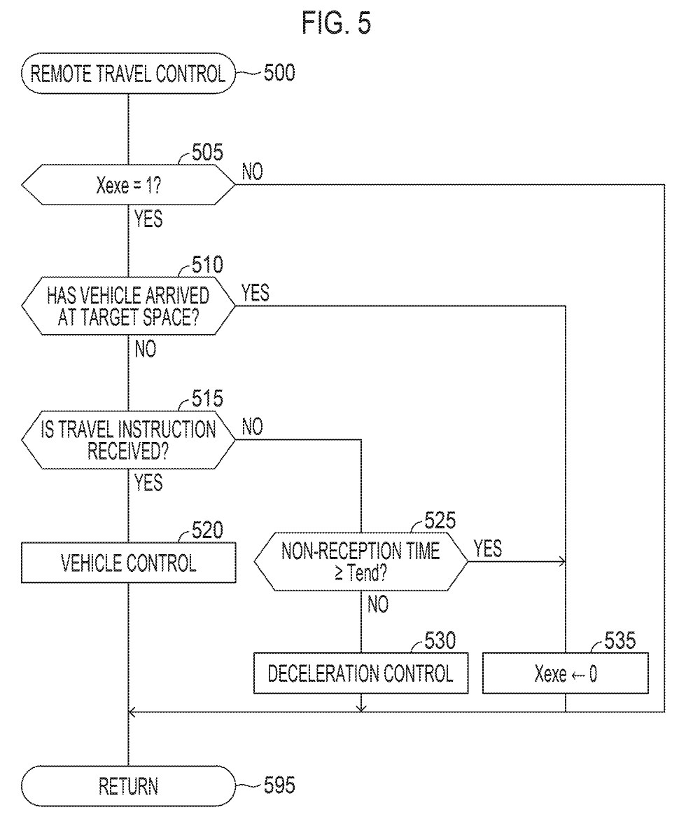

The second CPU executes a routine shown in a flowchart in FIG. 5 each time a predetermined time elapses.

When an appropriate point in time arrives, the second CPU starts the process from step 500, and the process proceeds to step 505. In step 505, the second CPU determines whether the execution flag Xexe is "1".

When the execution flag Xexe is "0", the second CPU determines "No" in step 505, and the process proceeds to step 595. In step 595, the second CPU temporarily ends the present routine.

On the other hand, when the execution flag Xexe is "1", the second CPU determines "Yes" in step 505, and the process proceeds to step 510. In step 510, the second CPU determines whether the vehicle VA has arrived at the target space.

When the vehicle VA has not arrived at the target space, the second CPU determines "No" in step 510, and the process proceeds to step 515. In step 515, the second CPU determines whether the device 10 has received the travel instruction from the portable terminal SP via the first communication.

When the device 10 receives the travel instruction, the second CPU determines "Yes" in step 515, and the process proceeds to step 520. In step 520, the second CPU controls the powertrain actuator 32, the brake actuator 34, and the steering motor 36 such that the vehicle VA travels along the traveling route. Thereafter, the process proceeds to step 595.

On the other hand, when the device 10 does not receive the travel instruction, the second CPU determines "No" in step 515, and the process proceeds to step 525. In step 525, the second CPU determines whether a non-reception time representing a time during which the device 10 has not received the travel instruction is equal to or longer than a predetermined end threshold time Tend.

When the non-reception time is shorter than the end threshold time Tend, the second CPU determines "No" in step 525, and the process proceeds to step 530. In step 530, the second CPU controls the powertrain actuator 32 and the brake actuator 34 such that the vehicle VA decelerates at a predetermined deceleration. Thereafter, the process proceeds to step 595.

When the non-reception time is equal to or longer than the end threshold time Tend, the second CPU determines "Yes" in step 525, and the process proceeds to step 535. In step 535, the second CPU sets the execution flag Xexe to "0". Thereafter, the process proceeds to step 595.

According to the present embodiment, when the activation condition is satisfied, the activation condition being that the device 10 receives activation data and the distance D is less than or equal to a threshold distance Dth, the first communication is established and the remote travel ECU 30 is activated. As a result, the time until the remote travel ECU 30 can execute the remote travel control can be reduced.

Further, when the remote travel application 14 is activated, the portable terminal SP transmits the activation data. Therefore, the user can execute the remote travel control by performing only the operation for activating the remote travel application 14 without requiring other operations.

The present disclosure is not limited to the above-described embodiment, and various modifications can be adopted within the scope of the present disclosure.

The first CPU may determine that the activation condition is satisfied when at least one of a first condition of receiving the activation data by the device 10 or a second condition of the distance D being equal to or less than the threshold distance Dth is satisfied.

When the first CPU determines that the activation condition is satisfied when only the second condition of the first condition and the second condition is satisfied, the electronic key application 12 need not be installed in the portable terminal SP. In this case, the function of the electronic key application 12 is implemented in an electronic key terminal different from the portable terminal SP. The electronic key terminal establishes the first communication with the vehicle VA and transmits and receives data.

The first communication and the second communication are not limited to Bluetooth (registered trademark) and BLE, respectively, and the first communication and the second communication may be communication using different communication protocols from each other.

The device 10 can be applied to a vehicle such as an engine vehicle, a hybrid electric vehicle, a plug-in hybrid vehicle, a fuel cell electric vehicle, and a battery electric vehicle. The remote travel control is a type of autonomous driving for supporting the driving of the user.

What is claimed is:

1. A remote travel device configured to receive, via first communication, a travel instruction transmitted from a portable terminal when a user outside a vehicle performs a predetermined remote operation on the portable terminal, and to cause a control unit to execute remote travel control of causing the vehicle that is parked to travel to a predetermined target space in response to the travel instruction, wherein the remote travel device is configured to
communicate, via second communication using a protocol different from a protocol of the first communication, with an electronic key terminal that is carried by the portable terminal or the user and that is used to perform unlocking and locking of a door of the vehicle, even when a vehicle power supply of the vehicle is in an off state,
determine, when the vehicle power supply is in the off state, whether an activation condition that is predetermined is satisfied based on a communication result of the second communication, and
establish, when the activation condition is satisfied, the first communication and turn on the vehicle power supply to activate the control unit.

2. The remote travel device according to claim 1, wherein the remote travel device is configured to
communicate with the portable terminal via the second communication even when the vehicle power supply is in the off state, and
when activation data transmitted from the portable terminal is received via the second communication when a remote travel application for causing the remote travel device to execute the remote travel control is activated on the portable terminal, determine that the activation condition is satisfied.

3. The remote travel device according to claim 1, wherein the remote travel device is configured to
specify a distance between the user and the vehicle based on the communication result of the second communication, and
when the distance is equal to or less than a threshold distance, determine that the activation condition is satisfied.

4. A remote travel device configured to receive, via first communication, a travel instruction transmitted from a portable terminal when a user outside a vehicle performs a predetermined remote operation on the portable terminal, and to cause a control unit to execute remote travel control of causing the vehicle that is parked to travel to a predetermined target space in response to the travel instruction, wherein the remote travel device is configured to
communicate, via second communication using a protocol different from a protocol of the first communication, with an electronic key terminal that is carried by the portable terminal or the user and that is used to perform unlocking and locking of a door of the vehicle,
determine whether an activation condition that is predetermined is satisfied based on a communication result of the second communication, and
establish, when the activation condition is satisfied, the first communication.
